(19) United States
(12) Patent Application Publication
(10) Pub. No.: US 2008/0102158 A1
(43) Pub. Date: May 1, 2008

(54) Edible Body Ornament

(75) Inventors: Tony W. Woodruff, Wausau, WI (US); Dawn M. Lambert, Schofield, WI (US)

Correspondence Address: Casimir Jones, S.C., 440 Science Drive, Suite 203, Madison, WI, 53711, US

(73) Assignee: Tony W. Woodruff, Wausau, WI (US)

(21) Appl. No.: 11/966,847

(22) Filed: Dec. 28, 2007

Related U.S. Application Data
(63) Continuation of application No. 11/043,319, filed on Jan. 26, 2005, now abandoned.

(51) Int. Cl. A23G 3/50; A23G 4/18

(52) U.S. Cl. 426/3; 426/104

(57) ABSTRACT

This invention relates to a novelty body ornament, and in particular to an edible, pliable ornament comprising a plurality of rings.

This application is a Continuation of co-pending application Ser. No. 11/043,319, filed Jan. 26, 2005, which is incorporated herein by reference.

### FIELD OF THE INVENTION

This invention relates to a novelty body ornament and in particular to edible, pliable rings for wear on one or more fingers or toes.

### BACKGROUND OF THE INVENTION

Oral contact with body parts such as toes is an aspect of social and sexual activity. Devices exist for enhancing the experience of oral-genital stimulation, e.g., by shielding the teeth from contact with soft body tissue. See, e.g., U.S. Pat. Nos. 5,970,981 and 6,244,269, each of which describe dental appliances for covering the teeth that are made in whole or in part of edible candy. These devices have been designed to be worn in the mouth of the person making the oral contact, e.g., to shield the teeth.

Edible genital ornaments are known in the art. For example, candy rings and edible condom-like sheaths scaled for wear on the penis are known in the art.

Candy jewelry, e.g., for children, is known in the art. For example, candy finger rings (e.g., Gummi friendship rings) are known in the art. However, such candy rings have been configured for children's wear, such that they are not dimensioned for wear by an adult. Further, such friendship rings are configured for wear on a single finger. Other examples of ring-shaped Gummi candy include candies comprising a toroid shape, wherein the candy is not configured to represent jewelry. Examples include LIFESAVERS brand GUMMIES candy and ROULETTES by Haribo. These candies comprise a doughnut or life preserver shape.

Other examples of edible ornaments include candy beads or disks that are strung together, e.g., on elastic string, as a necklace or bracelet. Some candy ornaments include edible and non-edible parts. In another example, under U.S. Pat. Nos. DE242646/242645, the use of a hard translucent candy resembling a gemstone attached to a finger ring holder is sold under the trademark “RINGPOP”.

### SUMMARY OF THE INVENTION

The present invention provides an edible body ornament for wear on a body part receiving oral contact or stimulation. In some embodiments the ornament comprises a ring structure. In preferred embodiments, the body ornament comprises two or more conjoined ring structures. In other preferred embodiments, the body ornament comprises two or more ring structures connected via an edible connector for wear, e.g., on one or more toes of the wearer.

In some embodiments, the two or more rings are worn on adjacent toes. In other embodiments, the rings are attached in a configuration to allow wearing on non-adjacent toes.

In some embodiments, the ornament of the present invention provides additional structures, e.g., for connecting to or encircling other parts of the foot, such as the ankle, under the arch, over the top of the metatarsals, etc., or to other parts of the body, including but not limited to the genitals.

In some embodiments, the edible ornament of the present invention comprises one or more surface elements. In some preferred embodiments, the surface elements comprise one or more knobs structures. In some preferred embodiments, the surface elements comprise one or more cone structures. In some embodiments, the surface elements are formed of the same edible material as the ring structures. In other embodiments, the surface elements are formed of a different edible material than the ring structures. In some preferred embodiments, the ring structures are formed of gelatin candy material and said surface elements are formed of hard candy.

In some embodiments, the edible ornament of the present invention comprises edible material comprising jellied candy material. In other embodiments, the edible ornament comprises an edible material comprising gelatin candy material. In yet other embodiments, the edible ornament of the present invention comprises edible material comprising licorice candy material. In still other embodiments, the edible ornament of the present invention comprises edible material comprising chewing gum material.

The present invention provides methods of wearing an edible ornament. In some embodiments, the method of wearing an edible ornament comprises placing an edible ornament comprising at least one ring structure formed of edible material on a foot, wherein at least one toe of the foot is inserted into the ring structure. In some embodiments, the edible ornament comprises a plurality of ring structures, and two or more toes of the foot are inserted into two or more of the plurality of ring structures of the edible ornament.

In some embodiments, the invention provides methods for wearing an edible ornament comprising a plurality of ring structures on a hand. In preferred embodiments, two or more fingers of the hand are inserted in two or more of the plurality of ring structures of the edible ornament.

In some embodiments, the invention provides methods of conducting oral stimulation. In some embodiments, the oral stimulation is of a foot or toe, and comprises providing an edible ornament comprising a ring structure on said foot or toe, and providing oral contact with the edible ornament on said foot or toe. In some embodiments, the edible ornament comprises a plurality of ring structures. In preferred embodiments, two or more toes are inserted in two or more of said plurality of ring structures.

In some embodiments, the invention provides methods for conducting oral stimulation of a hand, and comprises providing an edible ornament comprising a plurality of ring structures on said hand, wherein two or more fingers of said hand are inserted into two or more of said plurality of ring structures, and providing oral contact with the edible ornament on said hand.

### DESCRIPTION OF THE DRAWINGS

FIG. 1 shows one embodiment of a body ornament of the present invention comprising five conjoined ring structures, with hatched shading to show contours

### DEFINITIONS

To facilitate an understanding of the invention, a number of terms are defined below.

As used herein, the term “edible” refers to composition composed of food materials intended for oral contact or consumption by eating.

As used herein, the term “ring structure” refers to a structure or portion of a structure having a hole therethrough, including but not limited to a ring or doughnut shape. A ring structure may be essentially round like a doughnut, or may be formed of a square, triangle or another shape with a hole therethrough. As used herein, a ring structure does not require that the ring shape be unbroken, and the term is intended to encompass structures that are substantially closed, but that comprise a break or a gap in the ring shape. The term encompasses structures that comprise cavity, e.g., a “C” and “U”-shaped cavity, for receiving a body part, and that are configured to form a stable grip or hold on body part such as a finger or toe.

A ring structure may consist essentially of a single ring, or it may be a component of a larger structure having additional features, e.g., additional ring structures, or non-ring-shaped features such as corners, points, strings, etc.

As used herein, the term “surface element” refers to an element on the surface of another, supporting structural element, e.g., on the surface of a ring structure. Surface elements comprise any kind of shape, texture, image, flavor or the like that can be added to a supporting structure without changing the defining characteristics of the supporting structure (e.g., the doughnut shape of a round ring structure) and include but are not limited to beads, knobs, cones, strings, and the like.

As used herein, the term “conjoined” refers to attachment between two structures such that the structures are attached directly to each other, e.g., without a bridging element or connector between them.

As used herein, the term “connector” refers to a bridging element that attaches two or more structures to each other, wherein, at the site at which the connector is attached to each structural element, the elements are not conjoined.

As used herein, the term “oral contact” refers to a contact between a mouth (including but not limited to the lips, tongue and teeth) that is making the contact with an entity, such as an object or a body part, that is receiving such oral contact. Oral contact may be between the mouth and another body part of a single person, or may be between the mouth of one person and an object or a body part of another person.

### DESCRIPTION OF THE INVENTION

The present invention provides edible body ornaments. In particular, the present invention provides edible ornaments for wear on the digits of a hand or foot (e.g., on the toes or fingers). In preferred embodiments, the present invention provides an edible body ornament for wear on a body part, e.g., a toe, receiving oral contact.

In some embodiments the ornament comprises a plurality of ring structures. In preferred embodiments, the body ornament comprises two or more conjoined ring structures. In other preferred embodiments, the body ornament comprises two or more ring structures connected via an edible connector for wear, e.g., on one or more toes of the wearer.

The body ornaments of the present invention can be formed of edible flavored material such as, but not limited to, starch jellied candies, gelatin candy (e.g., GUMMI BEARS), caramels, flavored chewy candies such as TOOTSIE ROLLS and STARBURST candies, licorice, chewing gum, chocolate, hard candy, soft and hard candy combinations, and the like. It is an aspect of the invention that the body ornament is composed of a pliable or stretchable edible material, such that the ornament can be stretched to accommodate body parts, e.g., fingers or toes, of different sizes without discomfort. In preferred embodiments, the ornament of the present invention is made of a GUMMI-type gelatin candy comprising corn syrup, sugar, gelatin, and citric acid, or equivalents. Gelatin candy may also comprise dextrose, starch, artificial and/or natural flavors, fractionated coconut oil, carnauba wax, beeswax coating, and artificial and/or natural colors, or equivalents.

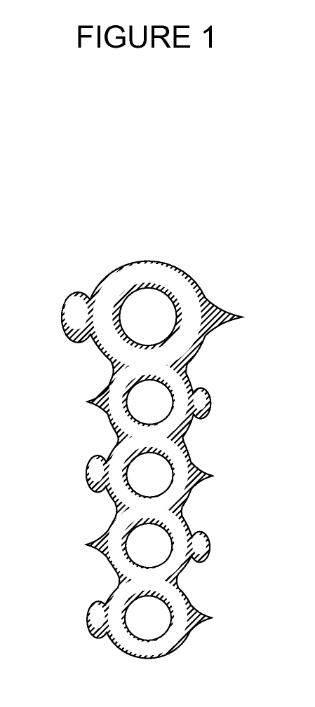

The body ornaments of the present invention can have smooth surfaces, rounded edges, dimpled-typed raised areas, combinations thereof, and the like. In some embodiments, the body ornaments of the present invention may comprise one or more surface elements. In preferred embodiments, the body ornament of the present invention comprises protruding surface elements. Protruding surface elements may comprise forms such as knobs, bumps, cones, or other three-dimensional shapes including but not limited to surface elements and forms such as are shown in FIG. 1. Surface elements may be composed of the same edible material as a supporting structure such a ring structure (e.g., the entire ornament may be composed of a jelly candy) or may the surface elements may comprise a different edible component (e.g., a candy or other edible material having a different texture, flavor or other composition variation from the composition of the basic ring structure). The body ornaments of the present invention may comprise additional edible components such as, but not limited to, edible glow-in-the-dark materials, flavored liquid centers such as those found in FRESHEN-UP gum, or gas releasing materials that cause a fizzle reaction when exposed to moisture, such as POP ROCKS by General Foods Corporation.

Formulas for making pliable, edible materials are well known in the art. For example, U.S. Pat. No. 6,244,269, incorporated herein by reference in its entirety, provides several examples of formulations and manufacturing processes for GUMMI-type gelatin candies.

Although the preferred embodiments have been described as using edible materials, the invention can be used with other materials such as but not limited to flavored silicone, flavored plastics, and the like, where the effect is also to provide a pliable flavored material that can be worn on a body part such as a finger or toe to receive oral contact.

All publications and patents mentioned in the above specification are herein incorporated by reference as if expressly set forth herein. Various modifications and variations of the described embodiments the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

I claim:

1. An edible ornament comprising a plurality of attached ring structures formed of edible material.

2. The edible ornament of claim 1 wherein said ornament comprises three or more ring structure.

3. The edible ornament of claim 1, wherein said ornament comprises four or more ring structures.

4. The edible ornament of claim 1, wherein said ornament comprises five or more ring structure.

5. The edible ornament of claim 1, wherein said plurality of attached ring structures comprises conjoined ring structures.

6. The edible ornament of claim 1, further comprising one or more edible connectors, wherein said plurality of attached ring structures comprises ring structures attached by an edible connector.

7. The edible ornament of claim 1, wherein said attached ring structures further comprise one or more surface elements.

8. The edible ornament of claim 7 wherein said surface elements comprise one or more knobs structures.

9. The edible ornament of claim 7, wherein said surface elements comprise one or more cone structures.

10. The edible ornament of claim 1, wherein said edible material comprises jellied candy material.

11. The edible ornament of claim 1, wherein said edible material comprises gelatin candy material.

12. The edible ornament of claim 1, wherein said edible material comprises licorice candy material.

13. The edible ornament of claim 1, wherein said edible material comprises chewing gum material.

14. The edible ornament of claim 7, wherein said surface elements are formed of the same edible material as the ring structures.

15. The edible ornament of claim 7, wherein said surface elements are formed of a different edible material than the ring structures.

16. The edible ornament of claim 15, wherein said ring structures are formed of gelatin candy material and said surface elements are formed of hard candy.

17. A method of wearing an edible ornament, comprising: placing an edible ornament comprising at least one ring structure formed of edible material on a foot, wherein at least one toe on said foot is inserted into at said at least one ring structure.

18. The method of claim 17, wherein said edible ornament comprises the edible ornament of claim 1, and wherein at least two toes of said foot are inserted into at least two of said plurality of ring structures.

19. A method of conducting oral stimulation, comprising:
a) providing an edible ornament comprising a ring structure formed of edible material on a toe; and
b) providing oral contact with said edible ornament on said toe.

20. The method of claim 19, wherein said edible ornament comprises the edible ornament of claim 1.
